(19) United States
(12) Patent Application Publication
(10) Pub. No.: US 2014/0079619 A1
(43) Pub. Date: Mar. 20, 2014

(54) MANUFACTURE OF PF5

(71) Applicant: HONEYWELL INTERNATIONAL INC., Morristown, NJ (US)

(72) Inventors: Matthew H. Luly, Hamburg, NY (US); Haridasan K. Nair, Williamsville, NY (US); Dan Hage, Paducah, KY (US)

(73) Assignee: Honeywell International Inc., Morristown, NJ (US)

(21) Appl. No.: 13/829,671

(22) Filed: Mar. 14, 2013

Related U.S. Application Data
(60) Provisional application No. 61/703,682, filed on Sep. 20, 2012.

(51) Int. Cl. C01B 25/10

(52) U.S. Cl. CPC C01B 25/10
USPC 423/301

(57) ABSTRACT

A process for producing phosphorus pentafluoride by the reaction of elemental phosphorus and elemental fluorine gas, comprising supplying to the reaction non-stoichiometric amounts of elemental phosphorus and elemental fluorine gas.

### CROSS REFERENCE TO RELATED APPLICATION

The present application claims priority under 35 U.S.C. §119(e) to U.S. Provisional Patent Application No. 61/703,682, filed on Sep. 20, 2012, the disclosure of which is incorporated herein by reference in its entirety.

### FIELD OF THE INVENTION

The present technology relates to the production of phosphorus pentafluoride (PF₅) from elemental phosphorus (P) and elemental fluorine gas (F₂).

### BACKGROUND OF THE INVENTION

Among commercially produced batteries, lithium ion batteries have one of the best energy-to-weight ratios, no memory effect, and a slow loss of charge when not in use. In addition to powering consumer electronics, lithium ion batteries are growing in popularity for defense, automotive, and aerospace applications due to their high energy density.

Lithium hexafluorophosphate (LiPF₆) is an electrolyte often used in lithium ion batteries. High purity phosphorus pentafluoride (PF₅) is required to make LiPF₆.

Some known methods for preparing phosphorus pentafluoride (PF₅) require further purification of the generated PF₅ to remove other reaction products. For example, one such method includes a two step process in which polyphosphoric acid is treated with excess hydrogen fluoride (HF) to produce hexfluorophosphoric acid, which then reacts with excess hydrogen fluoride (HF) and fuming sulfuric acid to produce phosphorus pentafluoride (PF₅). Another method comprises the fluorination of phosphorus pentachloride (PCl₅) with hydrogen fluoride (HF) to produce phosphorus pentafluoride (PF₅) along with hydrogen chloride (HCl) as described by the following formula:

PCl₅+5HF→PF₅+5HCl (1)

Phosphorus pentafluoride (PF₅) can also be prepared by reacting phosphorus trichloride (PCl₃) with elemental chlorine, bromine, or iodine and hydrogen fluoride (HF); or by the thermal decomposition (300° C.-1000° C.) of salts of hexafluorophosphoric acid (e.g., NaPF₆) as described by the following formula:

NaPF₆→NaF+PF₅ (2)

Additional processes of producing phosphorus pentafluoride (PF₅) along with other reaction products can be exemplified by the following reaction formulas:

3PCl₅+5AsF₃→3PF₅+5AsCl₃ (3)

5PF₃+3Cl₂→3PF₅+2PCl₃ (4)

POF₃+2HF→PF₅+H₂O (5)

Other methods of preparing phosphorus pentafluoride (PF₅) which are based on the reaction of elemental phosphorus include the low temperature fluorination of red phosphorus powder suspended in a solvent such as CFCl₃, and the fluorination of red phosphorus powder with an excess, such as about 1 to 10 fold excess, of a metal fluoride such as calcium fluoride (CaF₂).

Highly pure phosphorus pentafluoride (PF₅) can also be prepared by reacting elemental phosphorus (P) and elemental fluorine gas (F₂), wherein the relative amounts of elemental phosphorus and elemental fluorine gas charged to a reactor (via feed streams) and thus reacting with each other are precisely metered and thus tightly controlled to have the following stoichiometry: P+2.5 F₂→PF₅. See U.S. Publication No. 2010/0233057, which is incorporated herein by reference in its entirety.

### SUMMARY OF THE INVENTION

The invention provides a process for producing phosphorus pentafluoride by the reaction of elemental phosphorus and elemental fluorine gas, comprising supplying to the reaction non-stoichiometric amounts of elemental phosphorus and elemental fluorine gas.

In certain embodiments of the present invention, the elemental phosphorus is present in excess over the elemental fluorine gas. In other embodiments of the present invention, the process provides a phosphorus pentafluoride product wherein any non-phosphorus pentafluoride impurities are present at a concentration of less than 5 weight % of the total weight of the product. In other embodiments of the present invention, said non-phosphorus pentafluoride impurities are selected from the group consisting of PF₃, P₂F₄ and SiF₄. In other embodiments of the present invention, the reaction is carried out in a reactor by flowing elemental fluorine gas over a pool of molten elemental phosphorous. In other embodiments of the present invention, the elemental phosphorous comprises white phosphorous. In even other embodiments of the present invention, the reactor comprises internal baffles adapted to increase the contact between the elemental fluorine gas and the elemental phosphorus. In even other embodiments of the present invention, the reactor is connected to a secondary rector.

### BRIEF DESCRIPTIONS OF THE DRAWINGS

Specific examples have been chosen for purposes of illustration and description, and are shown in the accompanying drawings, forming a part of the specification. These examples and accompanying drawings should not be construed to limit the scope of the invention in any way.

FIG. 1 illustrates one embodiment of a system for producing PF₅ comprising a rectangular box-shaped reactor.

FIG. 2 illustrates another embodiment of a system for producing PF₅ comprising a tube-shaped reactor.

FIG. 3 illustrates another embodiment of a system for producing PF₅ comprising a conical reactor.

FIG. 4 illustrates another embodiment of a system for producing PF₅ comprising a spherical reactor.

FIG. 5 illustrates another embodiment of a system for producing PF₅ comprising a reactor, a feed reservoir and a storage tank.

FIG. 6 illustrates another embodiment of a system for producing PF₅ comprising a primary and a secondary reactor.

### DETAILED DESCRIPTION OF THE INVENTION

There is evidence in the literature that liquid elemental phosphorus exists as P₄ molecules. When liquid elemental phosphorus vaporizes, it is believed the vapor also consists of P₄ molecules up to a temperature of about 800° C. Above 800° C., P₄ is in equilibrium with diatomic phosphorus (P₂ molecules). Furthermore, diatomic phosphorus begins to break down to monatomic phosphorus at a temperature of above about 1500° C. The exact relationship among these species is complex and several species may be in equilibrium at a given temperature and pressure. One can describe the reaction of elemental phosphorus and elemental fluorine gas as 0.25 P₄+2.5 F₂→1 PF₅ over a range of conditions. However, depending on the exact temperature and pressure conditions, the phosphorus may exist in a different molecular form. For simplicity, we will use the formula P+2.5 F₂→PF₅ to describe the stoichiometry of the reaction of elemental phosphorus (P) and elemental fluorine gas (F₂), but do not mean to limit the scope of the present invention to the reaction of monatomic phosphorus with diatomic fluorine molecules. The term elemental phosphorus (abbreviated herein as P) as used herein refers to any allotrope of phosphorus commonly known in the art and the scope of the present invention encompasses the reaction of any such allotrope with elemental fluorine gas (F₂).

Correctly metering elemental phosphorus and elemental fluorine gas, both of which are very reactive, into a reactor in about stoichiometric amounts (i.e., in amounts wherein about one phosphorous atom is metered into the reactor for every five atoms of fluorine) to produce phosphorus pentafluoride is technically challenging and requires costly equipment. It is noted that, over time, liquid phosphorus tends to be transformed into solid red phosphorus, which is deposited on the surfaces of the process equipment; this can lead to down time. Moreover, it is hard to vaporize elemental phosphorus. There remains a need for improved methods of preparing phosphorus pentafluoride. The present invention addresses this need.

It has been found that the exact control of the reaction stoichiometry is not required to make highly pure phosphorus pentafluoride from elemental phosphorus and elemental fluorine gas, wherein the generated pentafluoride can be used for the production of lithium hexafluorophosphate without further purification. Even though phosphorus sublfuorides (non-limiting examples of which are PF₃, P₂F₄) are known compounds, they unexpectedly do not form when elemental phosphorus and elemental fluorine gas react in a reactor filled with an excess (averaged over the total reactor area) and thus non-stoichiometric amount of elemental phosphorus. Presumably, the F₂ is reacting primarily with P vapor above the pool of the phosphorous, but may also react with the liquid P at the surface of the pool. The term non-stoichiometric amount in the context of the present invention means that elemental phosphorus and elemental fluorine gas are provided to the reaction in relative amounts that diverge from the following formula: P+2.5 F₂→PF₅. A non-limiting example of non-stoichiometric amounts of elemental phosphorus and elemental fluorine gas according to the present invention is provided by a situation where the ratio of elemental phosphorus to elemental fluorine gas supplied to a reaction is about 2 P:2.5 F₂.

The present invention provides a process for producing phosphorus pentafluoride by the reaction of elemental phosphorus and elemental fluorine gas, comprising supplying to the reaction non-stoichiometric amounts of elemental phosphorus and elemental fluorine gas. The reaction of elemental phosphorus and elemental fluorine gas to produce phosphorus pentafluoride can be carried out in any of the many reactors commonly used in the art that has a convenient shape to hold elemental phosphorus.

In a preferred embodiment of the present invention, the reaction is carried out by flowing elemental fluorine gas over a pool of elemental phosphorous within a suitable reactor. Reactors holding such a pool of elemental phosphorous are sometimes called pool reactors.

In some embodiments of the present invention, the reactor has the shape of a rectangular box or of a horizontally oriented cylinder.

In certain embodiments of the present invention, the elemental phosphorus is supplied to the reaction in excess over the elemental fluorine gas, averaged over the total reactor. This means that more elemental phosphorus is charged to the reaction and present in the reaction than can react with the available elemental fluorine gas to phosphorus pentafluoride. It is noted that there may be a local excess of elemental fluorine gas at the immediate vicinity of the zone where elemental fluorine gas first contacts the elemental phosphorus.

At high temperatures, liquid white phosphorus can convert to solid red phosphorus. It is believed that small particles of red phosphorus form, then grow. When about 50% of the white phosphorus have converted to red phosphorus, the particles of red phosphorus begin touching each other, thereby forming a viscous liquid. When a little more red phosphorus forms, said viscous liquid turns solid. Within the present invention, the formation of red phosphorus is to be avoided.

In certain embodiments of the present invention, the elemental phosphorus in the reactor is molten. In certain embodiments of the present invention, the elemental phosphorus in the reactor comprises white phosphorus. In a preferred embodiment of the present invention, the elemental phosphorus in the reactor consists essentially of white phosphorus. In other embodiments of the present invention, the elemental phosphorus in the reactor comprises impurities of red phosphorus.

The elemental phosphorus and the elemental fluorine gas can be charged to the reactor in any of the many ways commonly known in the art. In certain embodiments of the present invention, the elemental phosphorus is charged to the reactor in batch form. In other embodiments of the present invention, the elemental phosphorus is charged to the reactor continuously. In a preferred embodiment of the present invention, the elemental phosphorus charged to the reactor consists essentially of white phosphorus. The elemental phosphorus may be charged to the reactor from a feed reservoir; the level of elemental phosphorus in this feed reservoir may be used to set the level of elemental phosphorus in the reactor. The phosphorus feed reservoir can optionally be supplied from a storage tank of molten elemental phosphorus. The elemental phosphorus charged to the reactor is preferably in molten form.

In certain embodiments of the present invention, the ratio of elemental phosphorus to elemental fluorine gas supplied to a reactor is more than 1 P:2.5 F₂. In other embodiments of the present invention, the ratio of elemental phosphorus to elemental fluorine gas supplied to a reactor is about 2 P:2.5 F₂, about 3 P:2.5 F₂, about 4 P:2.5 F₂, about 5 P:2.5 F₂, or more than about 5 P:2.5 F₂. As a general matter, the amount of phosphorus present in the reactor at any time is in great excess of the 0.2 P/F required for making PF₅. It is also in larger excess than the 0.33 P/F needed for PF₃ or the 0.5 P/F needed for P₂F₄.

The feed stream comprising elemental fluorine gas can also include an inert carrier gas, which can be introduced to the elemental fluorine gas feed stream. While not being bound by any particular theory, it is believed that an inert carrier gas can be useful for facilitating the flow of phosphorus pentafluoride product out of the reactor and for dissipating heat from the highly exothermic reaction between the elemental phosphorus and elemental fluorine, thereby controlling the temperature of the reactor. In non-limiting embodiments of the present invention where the feed stream comprising the elemental fluorine gas also comprises an inert carrier gas, the inert carrier gas and elemental fluorine gas are preferably present in the feed stream in a weight ratio of about 0.5:1 to about 20:1, and more preferably I a weight ratio of about 0.5:1 to about 10:1, based on the total weight of the feed stream. Examples of suitable inert gases that can be utilized as inert carrier gases include, but are not limited to, nitrogen (N₂), phosphorus pentafluoride (PF₅), hydrogen fluoride, and noble gases such as helium (He), neon (Ne), argon (Ar), and mixtures thereof. A benefit of using hydrogen fluoride as a diluent is that it allows the use of raw F₂ cell gas which can contain several percent of hydrogen fluoride, as opposed to purified F₂ with no/little hydrogen fluoride. Also, depending on the purpose for which the PF₅ is produced, it may not be necessary to remove the hydrogen fluoride from the produced PF₅ (for example, when PF₅ is used to make LiPF₆).

An inert carrier gas can also be supplied to the reactor independent of the feed stream of elemental fluorine gas.

Any inert carrier gas introduced into the system can, optionally, be separated from the phosphorus pentafluoride product prior to final processing. In one non-limiting example, inert carrier gas can be separated from the product stream via a separator downstream of the reactor. In certain embodiments of the present invention, the inert carrier gas can be recycled into the system.

In some situations, unreacted, excess elemental phosphorus vapor may be swept along with the phosphorus pentafluoride product. In certain embodiments of the present invention, a primary reactor, in which the reaction of PF₅ and F₂ primarily takes place, is connected to a secondary reactor within which the produced PF₅ is reacted with additional F₂ to ensure that any excess elemental phosphorus is converted to PF₅. Non-limiting examples of secondary reactors are a simple pipe (optionally jacketed for temperature control) and a packed bed to provide improved mixing and temperature control.

In other embodiments of the present invention, the produced PF₅ is reacted with additional elemental phosphorus in the secondary reactor to ensure that any excess F₂ is converted to PF₅.

Any unreacted phosphorus vapor in the PF₅ product can be removed/collected by passing said product through a condenser. The freezing/melting point of white phosphorus is about 44.2° C. and the boiling point is about 280.5° C. The boiling point of PF₅ is about −84.6° C. The present invention contemplates the condensation of unreacted phosphorus vapor at less than 280° C., more preferably at a temperature close to 44.2° C.

The elementary phosphorus and the elementary fluorine feed gas can be reacted within the reactor to produce phosphorus pentafluoride under any of the many known suitable reaction conditions. Preferably the temperature at which the reaction occurs at the interface of the liquid elementary phosphorus and the elementary fluorine feed gas is between about 44.2° C. and 280.5° C. A preferred range is 50° C. and 175° C. The pressure within the reactor is preferably from about 1 psia to about 70 psia, more preferably from about 10 psia to about 50 psia, and most preferably from about 10 psia to about 30 psia.

In certain embodiments of the present invention, the phosphorus pentafluoride product comprises non-PF₅ impurities at a concentration of less than 5 weight % of the total weight of the PF₅ product. In other embodiments of the present invention, the phosphorus pentafluoride (PF₅) product comprises non-PF₅ impurities at a concentration of from about 5 weight % to about 4 weight %, from about 4 weight % to about 3 weight %, from about 3 weight % to about 2 weight %, from about 2 weight % to about 1 weight %, from about 1 weight % to about 0.5 weight %, and from about 0.5 weight % to about 0.1 weight % of the PF₅ product. In certain embodiments of the present invention, the phosphorus pentafluoride product comprises non-PF₅ impurities at a concentration of less than 3 ppm, preferably less than 2 ppm, and even more preferably less than 1 ppm. In certain embodiments of the present invention, these non-PF₅ impurities are PₓF_{y} type impurities selected from the group consisting of PF₃ and P₂F₄. In other embodiments of the present invention, the non-PF₅ impurities are non-PₓF_{y} type impurities, for example, but not limited to SiF₄.

The concentration of non-PF₅ impurities in the phosphorus pentafluoride (PF₅) product is measured by infrared spectroscopy, a technique commonly used for this purpose.

In certain embodiments of the present invention, reactor geometries allow the adjustment of the surface area of the pool of elemental phosphorous, which provides additional control over the amount of elemental phosphorus available to react with the elemental fluorine gas. Non-limiting examples of such reactors include a horizontal cylinder, a vertical “funnel” (frustum of a right circular cone), or a spherical reactor (spherical segment).

In certain embodiments of the present invention, the reactor has a heating/cooling jacket and/or baffles in the gas phase to extend the contact of elemental fluorine gas (F₂) with the elemental phosphorus. Said baffles are adapted to increase the contact between the elemental fluorine gas and the elemental phosphorus. In other embodiments of the present invention, the reactor is equipped with other refinements generally known in the art.

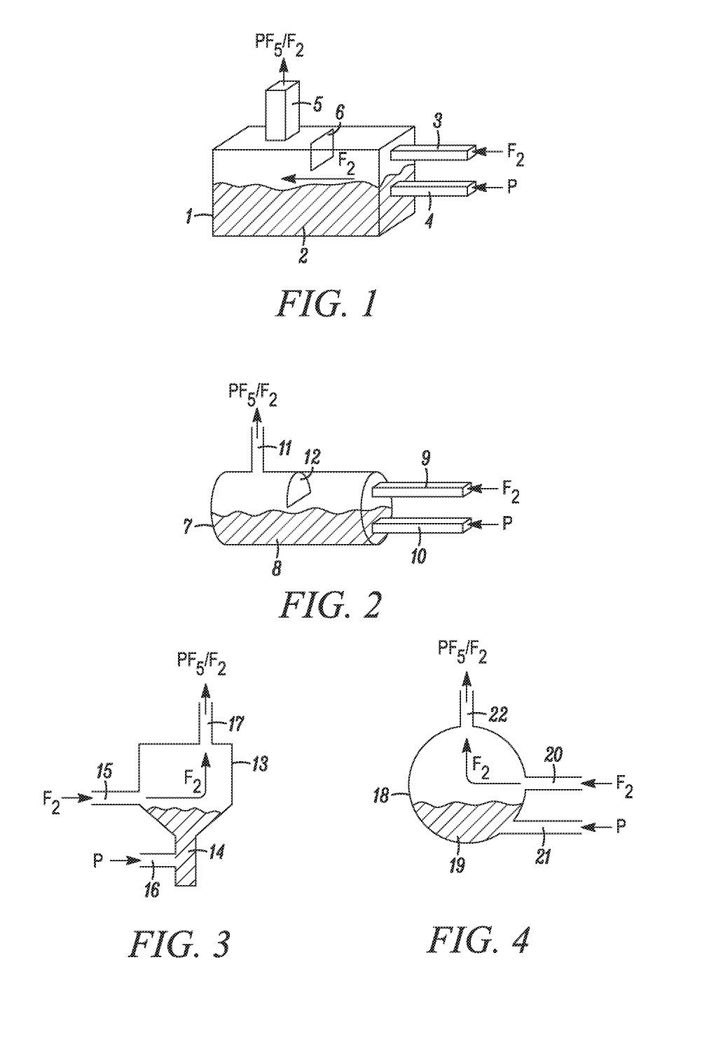

FIGS. 1-6 illustrate several non-limiting examples of reactor geometries that can be used in the context of the present invention. FIG. 1 illustrates a rectangular box-shaped reactor 1 that contains a pool of elemental phosphorous 2. Elemental fluorine gas enters the reactor through a first inlet member 3 and flows over this pool of elemental phosphorous. Elemental phosphorous enters the reactor through a second inlet member 4. PF₅ product and any unreacted elemental fluorine gas exit the reactor through an outlet member 5. The reactor also contains an optional baffle 6. The inlet and outlet members may have a valve (not indicated in FIG. 1).

FIG. 2 illustrates a tube-shaped reactor 7 that contains a pool of elemental phosphorous 8. Elemental fluorine gas enters the reactor through a first inlet member 9 and flows over this pool of elemental phosphorous. Elemental phosphorous enters the reactor through a second inlet member 10. PF₅ product and any unreacted elemental fluorine gas exit the reactor through an outlet member 11. The reactor also contains an optional baffle 12. The inlet and outlet members may have a valve (not indicated in FIG. 2).

FIG. 3 illustrates a conical reactor 13 that contains a pool of elemental phosphorous 14. Elemental fluorine gas enters the reactor through a first inlet member 15 and flows over this pool of elemental phosphorous. Elemental phosphorous enters the reactor through a second inlet member 16. PF₅ product and any unreacted elemental fluorine gas exit the reactor through an outlet member 17. The inlet and outlet members may have a valve (not indicated in FIG. 3).

FIG. 4 illustrates a spherical reactor 18 that contains a pool of elemental phosphorous 19. Elemental fluorine gas enters the reactor through a first inlet member 20 and flows over this pool of elemental phosphorous. Elemental phosphorous enters the reactor through a second inlet member 21. PF₅ product and any unreacted elemental fluorine gas exit the reactor through an outlet member 22. The inlet and outlet members may have a valve (not indicated in FIG. 4).

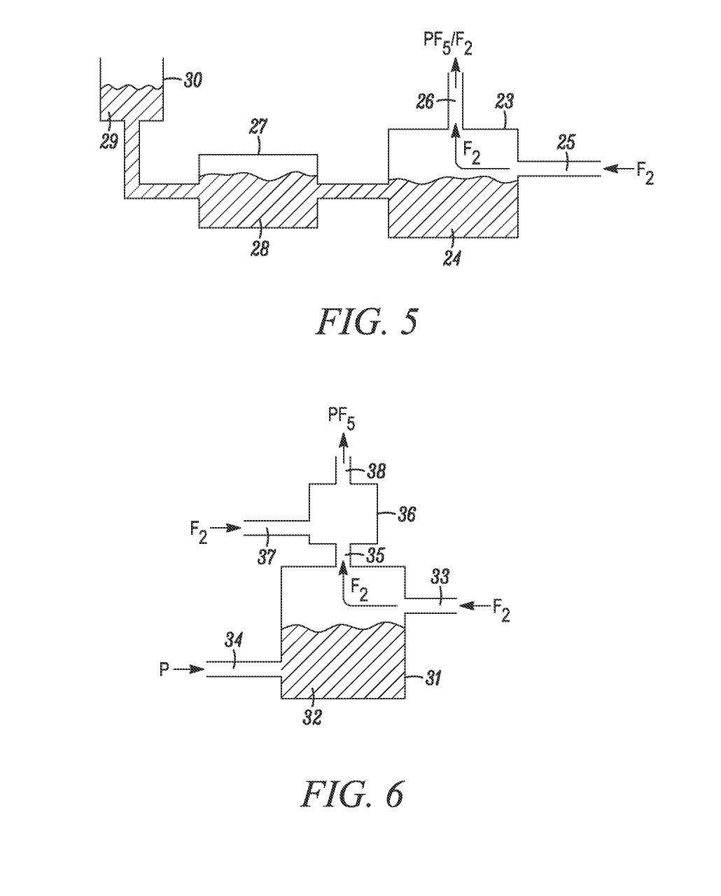

FIG. 5 illustrates a reactor configuration that includes a reactor 23 that contains a pool of elemental phosphorous 24. Elemental fluorine gas enters the reactor through an inlet member 25 and flows over this pool of elemental phosphorous. PF₅ product and any unreacted elemental fluorine gas exit the reactor through an outlet member 26. The pool of elemental phosphorous in the reactor is fed by feed reservoir 27 containing a pool of elemental phosphorous 28, which is fed by a pool of elemental phosphorous 29 in a storage tank 30. The inlet member may have a valve (not indicated in FIG. 5).

FIG. 6 illustrates a reactor configuration that includes a primary reactor 31 that contains a pool of elemental phosphorous 32. Elemental fluorine gas enters the reactor through a first inlet member 33 and flows over this pool of elemental phosphorous. Elemental phosphorous enters the reactor through a second inlet member 34. PF₅ product and any unreacted elemental fluorine gas exit the reactor through a first outlet member 35. The primary reactor 31 is connected to a secondary reactor 36 that reacts unreacted elemental phosphorous with elemental fluorine gas entering the secondary reactor through a third inlet member 37. The PF₅ product exits the secondary reactor through a second outlet member 38. The inlet and outlet members may have valves (not indicated in FIG. 6).

The following examples further illustrate the invention, but should not be construed to limit the scope of the invention in any way.

### EXAMPLES

### Example 1

About 40 g of white phosphorus, under a nitrogen purge, were placed in a Monel tube reactor (30 cm length×2.5 cm diameter), equipped with a valve on each end. The tube was heated with a heating tape and maintained at 50-60° C. so that the white phosphorus was in liquid phase (mp of white phosphorus=44° C.). The reactor was purged with nitrogen to remove any air or moisture and then a mixture of 20% elemental fluorine gas (F₂) and 80% N₂ was were passed over the molten phosphorus resulting in an exothermic reaction. The flow of diluted fluorine gas (5-50 sccm) was controlled with a mass flow controller. The progress of the reaction was gauged by the increase in temperature monitored by sensors placed along the outside of the reactor tube. The PF₅ product along with nitrogen was passed through two cooled traps at −78° C. and −196° C., respectively. The first trap condensed POF₃, phosphorus vapor (if any), and other high boiling impurities, while the second trap collected PF₅. The second trap was vented through an aqueous KOH (10-20%) scrubber solution. After the reaction, the trap at −196° C. was slowly brought to about −100° C. to remove any condensed fluorine, leaving pure PF₅. PF₅ was analyzed by IR and stored in a stainless container.

### Example 2

White phosphorus (100 g) under a nitrogen purge is placed in a 300 mL Monel autoclave, equipped with a stirrer, a temperature probe in the vapor space, and inlet and outlet valves. The molten elemental phosphorus is heated to and maintained at 60-100° C. and very slowly stirred. A mixture of 20% elemental fluorine gas (F₂) and 80% N₂ is slowly passed just above the surface of the molten elemental phosphorus. An exothermic reaction is monitored by the temperature sensor. The flow rate of diluted elemental fluorine gas (F₂) is such that the exotherm is controlled to be less than 300° C. Phosphorus pentafluoride thus produced is collected, purified and stored as described in Example 1.

### Example 3

Elemental fluorine gas (F₂) is introduced into a rectangular reactor which contains molten elemental phosphorus. The fluorine thus introduced reacts with the surface of the molten white phosphorous. PF₅ thus produced is collected, purified and stored as described in Example 1.

What is claimed is:

1. A process for producing phosphorus pentafluoride by the reaction of elemental phosphorus and elemental fluorine gas, comprising supplying to the reaction non-stoichiometric amounts of elemental phosphorus and elemental fluorine gas.

2. The process of claim 1, wherein the elemental phosphorus is present in excess over the elemental fluorine gas.

3. The process of claim 2, providing a phosphorus pentafluoride product wherein any non-phosphorus pentafluoride impurities are present at a concentration of less than 5 weight % of the total weight of the product.

4. The process of claim 3, wherein said non-phosphorus pentafluoride impurities are selected from the group consisting of PF₃, P₂F₄ and SiF₄

5. The process of claim 4, wherein the reaction is carried out in a reactor by flowing elemental fluorine gas over a pool of molten elemental phosphorous.

6. The process of claim 5, wherein the elemental phosphorous comprises white phosphorous.

7. The process of claim 6, wherein the reactor comprises internal baffles adapted to increase the contact between the elemental fluorine gas and the elemental phosphorus.

8. The process of claim 7, wherein the reactor is connected to a secondary rector.
